(19) United States
(12) Patent Application Publication
(10) Pub. No.: US 2011/0202892 A1
(43) Pub. Date: Aug. 18, 2011

(54) RETARGET PROCESS MODELING METHOD, METHOD OF FABRICATING MASK USING THE RETARGET PROCESS MODELING METHOD, COMPUTER READABLE STORAGE MEDIUM, AND IMAGING SYSTEM

(75) Inventors: Young-mi Lee, Suwon-si (KR); Young-chang Kim, Seoul (KR); Sung-soo Suh, Yongin-si (KR)

(73) Assignee: SAMSUNG ELECTRONICS CO., LTD., Suwon-si (KR)

(21) Appl. No.: 12/974,681

(22) Filed: Dec. 21, 2010

(30) Foreign Application Priority Data
Feb. 16, 2010 (KR) 10-2010-0013857

(51) Int. Cl. G06F 17/50

(52) U.S. Cl. 716/53

(57) ABSTRACT

In a retarget process modeling method, an effect according to density of patterns, and shapes or distances with respect to neighboring patterns may be sufficiently reflected while a relatively small amount of time and few costs are consumed. The retarget process modeling method involves obtaining prediction data, by a modelling calculating unit, on a test layout using a first process model, obtaining bias data based on measurement data of the test layout and the prediction data, using the bias data to check and detect corresponding features of a representative pattern affected by a photoresist (PR) flow rate, generating kernels including a PR flow kernel in consideration of a sub resolution assist feature (SRAF) pattern of the representative pattern to determine an uncalibrated model including the kernels and obtaining a second process model by fitting the uncalibrated model to the measurement data to obtain a second process model.

### CROSS-REFERENCE TO RELATED APPLICATIONS

This application claims the benefit of Korean Patent Application No. 10-2010-0013857, filed on Feb. 16, 2010, in the Korean Intellectual Property Office, the disclosure of which is incorporated herein in its entirety by reference.

### BACKGROUND

1. Field

Example embodiments of the inventive concepts relate to a mask used in a photolithography process, and more particularly, to a process modeling method of a mask layout in consideration of an optical proximity effect.

2. Description of the Related Art

Semiconductors have become highly integrated so that a gate length has become minute. Thus, when a mask pattern is transferred from a mask to a wafer, a pattern dimension may be resolved equal to or less than an optical wavelength used in an exposure apparatus.

In order to sufficiently resolve a pattern having a line width shorter than an optical wavelength, an optical proximity correction (OPC) technique is used to correct a shape of a mask pattern in consideration of pattern deformation on a wafer due to an optical proximity effect. The OPC technique is broadly divided into two OPC techniques, one of which is a rule-based OPC technique and the other one of which is a simulation-based OPC technique. Hereinafter, the two OPC techniques are briefly described.

According to the rule-based OPC technique, first, a test mask pattern is fabricated and then is transferred to a wafer so that a test wafer is fabricated. Afterward, based on measurement data with respect to a pattern formed on the test wafer and design data of a test mask, a design rule for determining bias data to be applied to the design data of a mask pattern is determined. Correction is performed in a layout computer-aided design (CAD) process of the mask pattern based on the design rule. According to the rule-based OPC technique, test patterns have to be measured for all patterns that are allowed in a design, and an operation for the rule-based OPC technique has to be repeated whenever a process is changed, such that the rule-based OPC technique is time consuming and costly.

According to the simulation-based OPC technique, kernels for representing a transferring process in consideration of an optical proximity effect are generated based on a measurement result of a relatively small number of previously arranged test patterns, that is, representative patterns. A difference between a shape of a mask pattern and a shape of a pattern transferred to a wafer is obtained via simulation by using a process model including the kernels, and the mask pattern is corrected according to a result of the simulation. According to the simulation-based OPC technique, measuring a relatively large number of test patterns is not necessary, which is advantageous in terms of time and cost. However, it is difficult to sufficiently reflect an effect according to density of patterns, and shapes or distances with respect to neighboring patterns.

### SUMMARY

The present invention provides a retarget process modeling method, a method of fabricating a mask using the retarget process modeling method, a computer readable storage medium, and an imaging system, whereby an effect according to density of patterns, and shapes or distances with respect to neighboring patterns may be sufficiently reflected while a relatively small amount of time and few costs are consumed.

In particular, the present invention provides a photoresist (PR) flow retarget process modeling method in consideration of a sub resolution assist feature (SRAF) pattern, a method of fabricating a mask using the PR flow retarget process modeling method, a computer readable storage medium, and an imaging system, whereby an effect with respect to a PR flow rate according to the SRAF pattern may be sufficiently reflected in a PR flow process used to overcome limitation of a resolution.

According to an example embodiment of the inventive concepts, there is provided a retarget process modeling method including obtaining prediction data, by a modelling calculating unit, on a test layout using a first process model; obtaining bias data based on measurement data of the test layout and the prediction data; using the bias data to check and detect corresponding features of a representative pattern affected by a photoresist (PR) flow rate; generating kernels including a PR flow kernel in consideration of a sub resolution assist feature (SRAF) pattern of the representative pattern to determine an uncalibrated model including the kernels; and obtaining a second process model by fitting the uncalibrated model to the measurement data.

In an example embodiment, the obtaining the bias data step may further include reflecting an After Development Inspection (ADI) critical dimension (CD) change of the representative pattern according to the PR flow rate. The using the bias data step may further include obtaining an After Flow Inspection (AFI) contour from an ADI model contour after an optical proximity correction (OPC) is performed by the first process model before correction.

In an example embodiment, the PR flow kernel may further include a visible kernel in consideration of a space between patterns, a blocked kernel in consideration of a width of a pattern, a density kernel in consideration of a density of a pattern, and an SRAF density kernel in consideration of pattern density of the SRAF. The SRAF density kernel may reflect the PR flow rate in such a manner that an effect of the SRAF pattern according to regions or pattern sizes of the SRAF pattern is subdivided and reflected thereto.

In an example embodiment, the SRAF density kernel may reflect the PR flow rate by varying according to a direction of the SRAF pattern, a size of the SRAF pattern, and a distance between a main pattern and the SRAF pattern. The variation may be performed in such a manner that different weights are added to sections of the SRAF pattern divided according to a rule. The SRAF density kernel may be generated by dividing a radius R of a region in the visible kernel by a number n so as to divide the region into n radius sections each having a radius of R×(1 through n)/n, by dividing the region into m angle sections on either side of a center line, and by adding a same weight to each of n×m sections.

In an example embodiment, angles corresponding to positions of the SRAF pattern on either side of the center line may be references in dividing the region in the visible kernel into m angle sections.

According to another example embodiment of the inventive concepts, a method of fabricating a mask includes generating a test mask according to a test layout with respect to a representative pattern; obtaining measurement data using the test mask by performing an exposure operation on the representative pattern; performing the retarget process modeling method of the example embodiment; and generating a layout for the mask based on the second process model.

In an example embodiment, the using the bias data step may further include obtaining an After Flow Inspection (AFI) contour from an ADI model contour after an optical proximity correction (OPC) is performed by the first process model before correction. The PR flow kernel may further include a visible kernel in consideration of a space between patterns, a blocked kernel in consideration of a width of a pattern, a density kernel in consideration of a density of a pattern, and an SRAF density kernel in consideration of pattern density of the SRAF. The SRAF density kernel may reflect the PR flow rate in such a manner that an effect of the SRAF pattern according to regions or pattern sizes of the SRAF pattern is subdivided and reflected thereto.

According to another example embodiment of the inventive concepts, a computer readable storage medium stores commands programmed to allow the retarget process modeling method of the example embodiment to be executed in a computer.

In an example embodiment, the PR flow kernel may further include a visible kernel in consideration of a space between patterns, a blocked kernel in consideration of a width of a pattern, a density kernel in consideration of a density of a pattern, and an SRAF density kernel in consideration of pattern density of the SRAF, and the SRAF density kernel may reflect the PR flow rate in such a manner that an effect of the SRAF pattern according to regions or pattern sizes of the SRAF pattern is subdivided and reflected thereto.

According to another example embodiment of the inventive concepts, an imaging system includes a measurement data detecting unit configured to detect measurement data of patterns formed on a wafer; a modelling calculating unit configured to perform the retarget process modeling method of the example embodiment based on the measurement data; a mask layout generating unit configured to generate a layout of a mask based on the second process model obtained by performing the retarget process modeling method; and an illumination unit configured to provide illumination in an exposure process using the mask, wherein the illumination unit corresponds with the kernels.

In an example embodiment, the using the bias data step may further include obtaining an After Flow Inspection (AFI) contour from an ADI model contour after an optical proximity correction (OPC) is performed by the first process model before correction. The PR flow kernel may further include a visible kernel in consideration of a space between patterns, a blocked kernel in consideration of a width of a pattern, a density kernel in consideration of a density of a pattern, and an SRAF density kernel in consideration of pattern density of the SRAF.

In an example embodiment, the SRAF density kernel may reflect the PR flow rate in such a manner that an effect of the SRAF pattern according to regions or pattern sizes of the SRAF pattern is subdivided and reflected thereto. The SRAF density kernel may reflect the PR flow rate by varying according to a direction of the SRAF pattern, a size of the SRAF pattern, and a distance between a main pattern and the SRAF pattern.

### BRIEF DESCRIPTION OF THE DRAWINGS

Example embodiments of the inventive concepts will be more clearly understood from the following detailed description taken in conjunction with the accompanying drawings in which:

FIG. 1 is a flowchart of a retarget process modelling method according to an example embodiment of the inventive concepts;

FIG. 2 is a graph for illustrating a skew with respect to a space in a case where an effect of an sub resolution assist feature (SRAF) pattern is considered and in another case where the effect of the SRAF pattern is not considered;

FIG. 3 is a diagram of example patterns for further describing the retarget process modelling method of FIG. 1;

FIGS. 4A through 4D are concept diagrams for illustrating photoresist (PR) flow kernels that may be included for a retarget process modelling operation in the RF flow process of the example patterns of FIG. 3;

FIG. 5 is a flowchart of a method of fabricating a mask, according to another example embodiment of the inventive concepts; and

FIG. 6 is a block diagram of an imaging system, according to an example embodiment of the inventive concepts.

### DETAILED DESCRIPTION OF THE EMBODIMENTS

The attached drawings for illustrating example embodiments of the inventive concepts are referred to in order to gain a sufficient understanding of the inventive concepts, the merits thereof, and the objectives accomplished by the implementation of the inventive concepts. Throughout the specification, it will also be understood that when an element is referred to as being “on” another element, it can be directly on the other element, or intervening elements may also be present. In the drawings, the thicknesses of layers and regions are exaggerated for convenience of description and clarity, and portions irrelevant to the description are omitted. In the drawings, like reference numerals denote like elements. While the inventive concepts have been particularly shown and described with reference to example embodiments thereof, it will be understood that various changes in form and details may be made therein without departing from the spirit and scope of the following claims. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes”, and/or “including” when used in this application, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Example embodiments of the inventive concepts are described herein with reference to (plan and) cross-section illustrations that are schematic illustrations of idealized embodiments of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. Thus, the elements illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

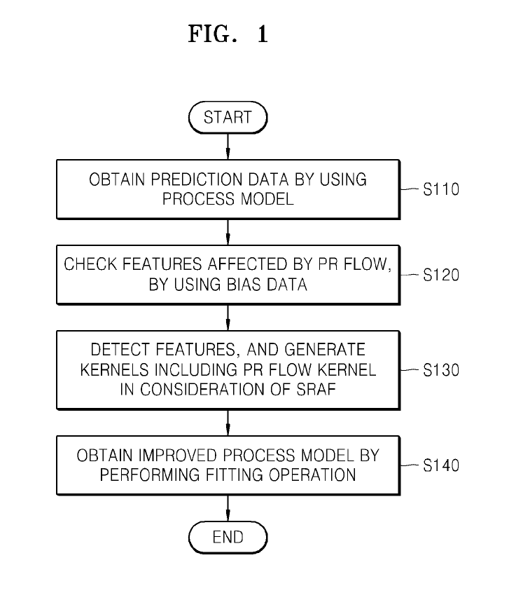

FIG. 1 is a flowchart of a retarget process modelling method according to an example embodiment of the inventive concepts. Referring to FIG. 1, the retarget process modelling method according to the example embodiment of the inventive concepts involves obtaining prediction data on a test layout by using an existing process model (operation S110). To be more specific, in order to fabricate a test mask for representative patterns, the test layout is designed, and the existing process model is applied to the test layout so as to obtain the prediction data to be formed on a wafer. Here, a representative pattern is a pattern capable of representing corresponding process models, and is appropriately selected in consideration of geometrical shapes of patterns, an operation characteristic of a device, sizes of the patterns, a frequency of patterns, performance or non-performance of a photoresist (PR) flow, and the existence or non-existence of a sub resolution assist feature (SRAF) pattern. In particular, according to the example embodiment of the inventive concepts, the representative pattern may be selected in consideration of performance or non-performance of the PR flow, and existence or non-existence of the SRAF pattern.

For reference, the PR flow process is performed to overcome a resolution limitation, and involves changing a critical dimension (CD) by allowing a PR to flow among patterns by performing an appropriate thermal treatment after an exposure process. When patterns are formed as a higher density region and a lower density region in one chip, the SRAF pattern functions as an auxiliary pattern introduced to solve a deviation occurrence due to an optical proximity correction (OPC) since the higher density region and the lower density region have different diffraction shapes due to their optical characteristics. The SRAF pattern is not actually formed on the wafer.

Measurement data is obtained regarding actual patterns that are formed on the wafer in such a manner that the test mask is fabricated by using the test layout, and then an exposure operation is performed by using the test mask. The existing process model indicates a process model that is not considered the PR flow nor considered a PR flow due to an effect of the SRAF pattern.

Bias data is obtained by comparing the measurement data and the prediction data, and then the bias data is used in checking corresponding features affected by the PR flow (operation S120). That is, the bias data may be used to obtain an After Flow Inspection (AFI) contour from an After Development Inspection (ADI) model contour, after the OPC is performed by the process model before correction.

After checking the corresponding features, the corresponding features are detected, and kernels including a PR flow kernel in consideration of an SRAF are generated (operation S130).

A kernel indicates a function for allowing appropriate space frequencies to be generated in correspondence to a lighting condition and/or an arranged photolithography apparatus, and functions to generate a projection pattern by being convolution-calculated with a pattern to be formed on a device. A plurality of the kernels may be generated in correspondence to corresponding patterns, and a sum of the plurality of kernels is referred to as a Point Spread Function (PSF).

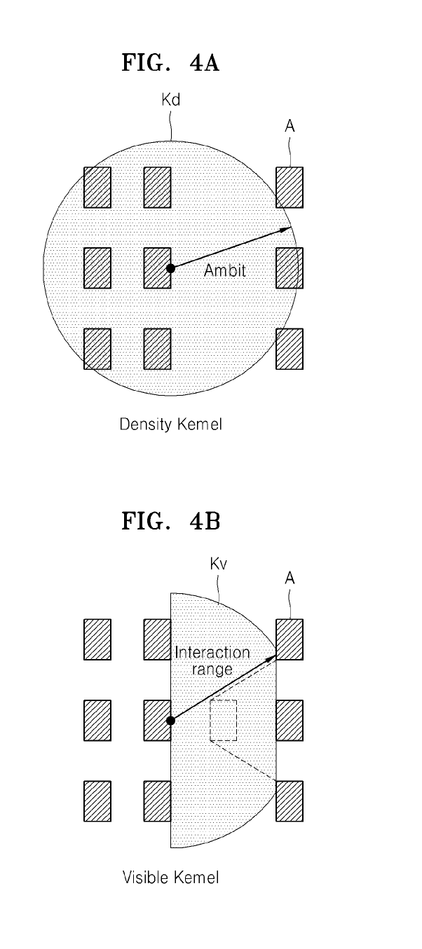

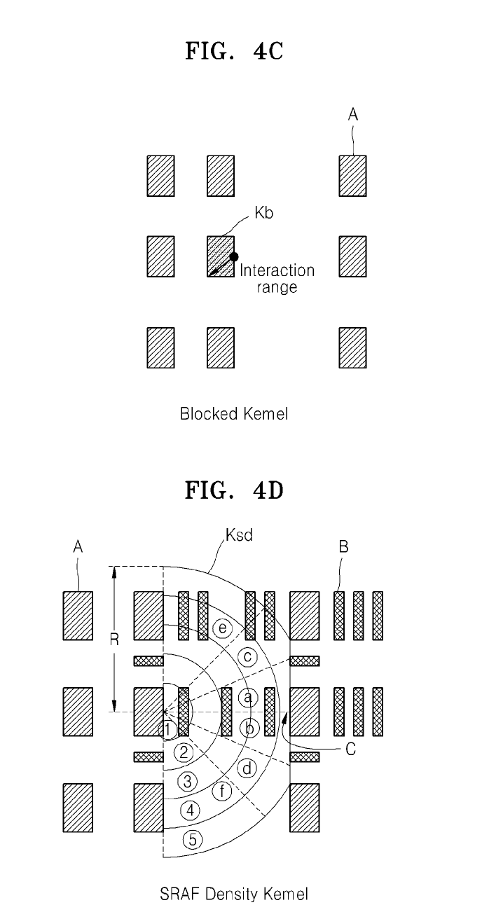

The kernel in the example embodiment of the inventive concepts not only includes a kernel representing a basic pattern but also includes a PR flow kernel in consideration of an effect of a PR flow rate in a PR flow process. Particularly, in the example embodiment of the inventive concepts, existence of the SRAF pattern is considered in the PR flow kernel. The PR flow kernel will be described in detail by using an example pattern including the SRAF pattern, with reference to FIGS. 3 through 4D.

After the kernels are generated, an uncalibrated model including the kernels is determined and then is fitted by being applied to the measurement data, so that an improved process model is obtained (operation S140). The process model may be used in various processes of design and fabrication procedures. For example, in the OPC, when proximity correction allowed by a system is determined to generate a desirable feature shape on the wafer, the process model according to the example embodiment of the inventive concepts may be used. In general, the process model may be determined by fitting kernel coefficients on the measurement data. The measurement data may be generated by applying one or more test layouts to a modelled semiconductor fabricating process. For example, the test layout is transferred to the wafer via the photolithography process, and a CD of features formed on the wafer is measured so that the measurement data may be obtained.

The retarget process modeling method according to the example embodiment of the inventive concepts involves generating corresponding kernels in consideration of density of the SRAF pattern affecting the PR flow rate in a patterning process in which the PR flow process is performed, obtaining the improved process model based on the kernels, and then generating a process model capable of sufficiently reflecting an actual PR flow rate.

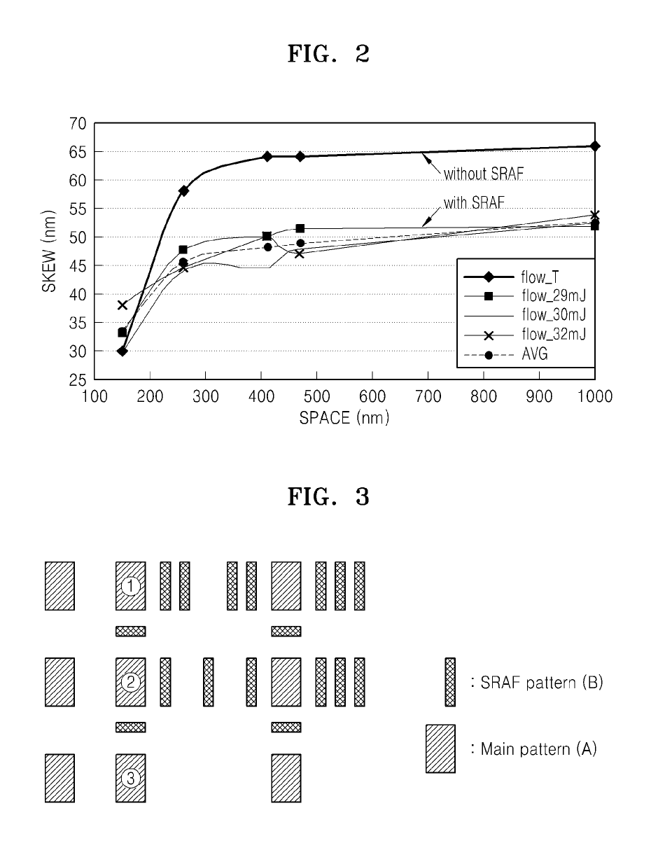

FIG. 2 is a graph for illustrating a skew with respect to a space where an effect of an SRAF pattern is considered and in another case where the effect of the SRAF pattern is not considered. Here, the space in an X-axis indicates a space between patterns, and the skew in a Y-axis indicates an inclination degree caused by a PR flow, that is, the skew indicates a CD change.

Referring to FIG. 2, an uppermost graph line denoted as -♦- indicates a case without the SRAF pattern, and lower graph lines denoted as -▪-, -—-, -x- and -- indicate cases with the SRAF pattern. To be more specific, the lower graph lines denoted as -▪-, -—-, and -x- indicate cases in which an exposure dose amount slightly varies and other process conditions are the same, and the lower graph line denoted as -- indicates a case corresponding to an average of the graph lines of the cases with the SRAF pattern.

As illustrated in the graph, the skew of the cases with the SRAF pattern and the skew of the case without the SRAF pattern differ by about 15 nm. This difference is an amount occupying 25% of a main pattern in a 65 nm device. The reason for the skew difference is as follows.

As described above, the SRAF pattern is not actually patterned on the wafer. Thus, the SRAF pattern on a mask transmits light, and a PR existing at a position of the SRAF pattern receives the light, so that a characteristic of the PR is changed. As a result, a flow rate of the PR having received the light, and a flow rate of a PR not having received the light in a PR flow process become different, so that the skew difference occurs.

Due to the aforementioned reason, if the SRAF pattern is not considered in a retarget process modelling operation for the PR flow process, a pattern width that is different from an intention of a designer is generated, and thus, serious problems including a decrease in manufacturing yield and/or a shortage of an overlay margin are caused. As a result, there is no choice but to re-fabricate a mask.

The retarget process modelling operation in consideration of a PR flow is performed on a layer to which the PR flow process is performed. The retarget process modelling operation in consideration of the PR flow may be broadly divided into two methods.

The first method involves giving a retarget in consideration of the dimension of a space between patterns without considering peripheral environments of the patterns. However, a PR flow rate may be affected according to the existence of an adjacent pattern in the PR flow process. Thus, the retarget process modelling operation performed without considering the peripheral environments may not sufficiently reflect an actual pattern.

The second method involves giving a retarget in consideration of a peripheral environment of a pattern, that is, in consideration of a density of main patterns, a space between the main patterns, a pattern shape and the like. For example, a density kernel according to density of patterns, a visible kernel according to a space between patterns, and a blocked kernel according to a width of a pattern are inducted. By calibrating the existing process model, i.e., by performing the retarget process modelling operation by using the kernels, a process model capable of sufficiently reflecting an actual pattern may be obtained.

For reference, the retarget process modelling operation in consideration of the peripheral environment of the pattern may be applied not only to the PR flow process but also applied to an etching process. The retarget process modelling operation with respect to the PR flow reflects a CD difference between ADI and AFT, whereas the retarget process modelling operation with respect to the etching process reflects a CD difference between ADI and After Clean Inspection (ACI).

Meanwhile, as illustrated in the graph, in a case in which the SRAF pattern exists in addition to the main patterns, the skew varies according to the existence of the SRAF pattern, so that the retarget process modelling operation with respect to the PR flow process may not be exactly performed by using only the three kernels with respect to the main patterns.

FIG. 3 is a diagram of example patterns for further describing the retarget process modelling method of FIG. 1. Referring to FIG. 3, the example patterns include main patterns (A) and SRAF patterns (B). In a PR flow process, as described above, a PR flow rate is affected by a density, a space, and a pattern shape of a main pattern, and the PR flow rate is changed by the existence or non-existence of an SRAF pattern. Thus, it is important to generate kernels capable of sufficiently reflecting the example patterns.

Here, with respect to the main patterns (A), \textcircled{1}, \textcircled{2}, and \textcircled{3} patterns have the same space and shape in their right side. However, if the SRAF patterns (B) are considered, it is possible to see that the \textcircled{1}, \textcircled{2}, and \textcircled{3} patterns have different peripheral environments. If the kernels are generated in consideration of only the main patterns (A), the same retarget is given to the main patterns (A). However, due to the existence of the SRAF patterns (B), an actual PR flow rate for each of the \textcircled{1}, \textcircled{2}, and \textcircled{3} patterns is different so that a different retarget has to be given to each of the \textcircled{1}, \textcircled{2}, and \textcircled{3} patterns.

FIGS. 4A through 4D are concept diagrams for illustrating PR flow kernels that may be included for a retarget process modelling operation in the RF flow process of the example patterns of FIG. 3.

FIG. 4A illustrates a density kernel Kd with respect to the example patterns. The density kernel Kd is a kernel in consideration of an effect of pattern density existing in an ambit indicating an interaction range that affects patterns. For example, the density kernel Kd may have a form of a circle with a radius corresponding to a distance from a center pattern to a farthest adjacent pattern.

FIG. 4B illustrates a visible kernel Kv with respect to the example patterns. The visible kernel Kv is a kernel in consideration of a space between patterns. For example, the visible kernel Kv may have a form connecting patterns adjacent to a center pattern. As illustrated by using a dotted line, if a different pattern exists in a front side of the center pattern, patterns existing in a rear side of the different pattern are not considered.

FIG. 4C illustrates a blocked kernel Kb with respect to the example patterns. The blocked kernel Kb is a kernel in consideration of a width of a pattern. For example, the blocked kernel Kb may have a form in consideration of an interaction according to the width of the pattern, without considering peripheral patterns.

FIG. 4D illustrates an SRAF density kernel Ksd with respect to the exemplary patterns. The SRAF density kernel Ksd is a kernel in consideration of SRAF patterns. The SRAF density kernel Ksd has to exist within a visible kernel region. The SRAF density kernel Ksd is generated in consideration of the SRAF patterns existing between main patterns and affecting an actual PR flow, not in consideration of a density of a main pattern in the ambit as the aforementioned density kernel Kd.

In the example embodiment of the inventive concepts, the SRAF density kernel Ksd may be generated in the following manner. A radius R of Ksd is divided by a predetermined or given number n, and thus is divided into n radius sections. In FIG. 4D, the radius R is divided into 5 sections \textcircled{1} through \textcircled{5}, the number of sections being predetermined or given number. Such divided n radius sections are divided into m angle sections on either side of a center line C. Here, m is 3, and thus the angle sections are divided into 3 angle sections on either side of the center line C. To be more specific, with respect to the center line C, the angle sections are divided into \textcircled{a} and \textcircled{b} sections in 0° through ±22.5°, \textcircled{c} and \textcircled{d} sections in ±22.5° through ±45°, and \textcircled{e} and \textcircled{f} sections in ±45° through ±90°.

The angle sections may be divided to have the same angle, however, the angle sections may be divided by angles corresponding to positions of the SRAF patterns on either side of the center line C. In a case where the angle sections are divided according to the positions of the SRAF patterns, the angle sections may be further divided in correspondence to the SRAF pattern existing in the \textcircled{e} section. Further division of the angle sections may be appropriately selected in consideration of exactness and time of the retarget process modelling operation. That is, as a section is further divided, the exactness of the retarget process modelling operation is increased and the time of the retarget process modelling operation is increased.

In this manner, the radius sections are divided into n×m, that is, 5×3=15, sections, and different weights are added to the 15 sections, so that the SRAF density kernel Ksd is generated. All sections may have different weights, but it is also possible to group all the sections into several groups and then to add different weights to the several groups, respectively.

By adding the density kernel Kd, the visible kernel Kv, the blocked kernel Kb, and the SRAF density kernel Ksd to the existing process model, a retarget process model in consideration of the SRAF pattern with respect to the PR flow process may be generated. In particular, since the SRAF density kernel Ksd in consideration of the SRAF pattern is included, it is possible to solve a problem in which the existing process model does not correctly represent the PR flow process due to existence of the SRAF pattern.

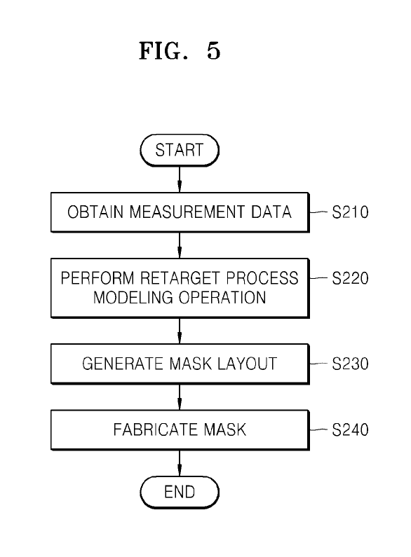

FIG. 5 is a flowchart of a method of fabricating a mask according to another example embodiment of the inventive concepts. Referring to FIG. 5, the method of fabricating the mask according to another example embodiment of the inventive concepts involves generating a test mask according to a test layout with respect to a representative pattern, performing an exposure operation by using the test mask, and obtaining measurement data (operation S210). A retarget process modelling operation is performed (operation S220). Here, the retarget process modelling operation indicates the retarget process modelling operation of FIG. 1 which involves generating the kernels in consideration of the main patterns or the SRAF patterns in the PR flow process. Since the retarget process modelling operation is already described in detail with reference to FIG. 1 and FIGS. 3 through 4D, a detailed description thereof will be omitted here.

A layout for the mask is generated based on an improved process model obtained by performing the retarget process modelling operation (operation S230). When the mask layout is generated, the mask is fabricated according to the mask layout (operation S240).

Since the method of fabricating the mask according to the example embodiment of inventive concepts facilitates fabrication of the mask corresponding to a target pattern in the PR flow process by performing the retarget process modelling operation, solving a problem including a decrease in manufacturing yield or a shortage of an overlay margin, which is caused due to actual patterns having widths different from a design due to the existence of SRAF patterns, may be possible.

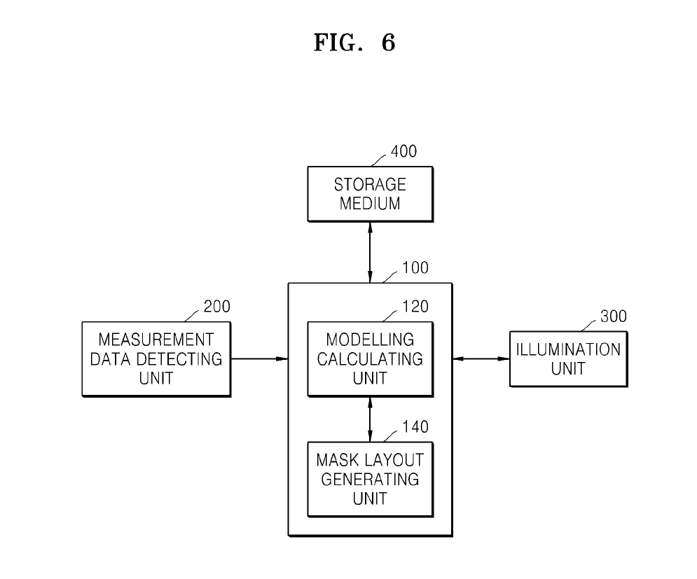

FIG. 6 is a block diagram of an imaging system, according to an example embodiment of the inventive concepts. Referring to FIG. 6, the imaging system 100 according to the example embodiment of the inventive concepts includes a measurement data detecting unit 200, a modelling calculating unit 120, a mask layout generating unit 140, an illumination unit 300, and a storage medium 400.

The measurement data detecting unit 200 detects measurement data about patterns formed on a wafer, and provides the measurement data to the modelling calculating unit 120. The measurement data may be stored in the storage medium 400 and provided to the modelling calculating unit 120. The modelling calculating unit 120 performs the retarget process modelling operation described with reference to FIG. 1 and FIGS. 3 through 4D, and the mask layout generating unit 140 generates a layout of a mask based on the retarget process modelling operation. The modelling calculating unit 120 and the mask layout generating unit 140 may be a part of a computer system 100 including a processor capable of executing one or more programs.

The illumination unit 300 provides illumination in an exposure process, and may correspond to a kernel function that allows appropriate space frequencies to be generated in correspondence to an illumination condition.

The storage medium 400 may store a series of computer executable commands. For example, the storage medium 400 may store commands programmed to allow the aforementioned operations to be executed when the modelling calculating unit 120 executes the retarget process modelling operation. The storage medium 400 may be computer-readable, and may include various mediums including a floppy disk, a hard disk drive (HDD), CD-ROM, dynamic random access memory (DRAM), static random access memory (SRAM), a flash memory, and the like.

Although not illustrated in the drawings, the imaging system according to the example embodiment of inventive concepts may include various devices such as an optical source, a lens, a reflective mirror or the like.

The retarget process modeling method, the method of fabricating a mask using the retarget process modeling method, the computer readable storage medium, and the imaging system according to the one or more example embodiments of the inventive concepts may generate the improved process model capable of sufficiently reflecting the actual PR flow rate in consideration of the density of the SRAF pattern affecting the PR flow rate, in the patterning process in which the PR flow is performed to overcome the limitation of resolution and includes the SRAF pattern on which a patterning is not performed.

Accordingly, the retarget process modeling operation according to one or more example embodiments of the inventive concepts may reduce loss due to a decrease in manufacturing yield, a shortage of an overlay margin, and remanufacture of the mask which are caused by using the existing process model, and may considerably improve the manufacturing yield by allowing a mask, which fulfils a target pattern, to be generated.

While the inventive concepts have been particularly shown and described with reference to example embodiments thereof, it will be understood that various changes in form and details may be made therein without departing from the spirit and scope of the following claims.

1. A retarget process modeling method comprising:
obtaining prediction data, by a modelling calculating unit, on a test layout using a first process model;
obtaining bias data based on measurement data of the test layout and the prediction data;
using the bias data to check and detect corresponding features of a representative pattern affected by a photoresist (PR) flow rate;
generating kernels including a PR flow kernel in consideration of a sub resolution assist feature (SRAF) pattern of the representative pattern to determine an uncalibrated model including the kernels; and
obtaining a second process model by fitting the uncalibrated model to the measurement data.

2. The retarget process modeling method of claim 1, wherein the obtaining the bias data step further comprises reflecting an After Development Inspection (ADI) critical dimension (CD) change of the representative pattern according to the PR flow rate.

3. The retarget process modeling method of claim 2, wherein the using the bias data step further comprises obtaining an After Flow Inspection (AFI) contour from an ADI model contour after an optical proximity correction (OPC) is performed by the first process model before correction.

4. The retarget process modeling method of claim 1, wherein the PR flow kernel further comprises a visible kernel in consideration of a space between patterns, a blocked kernel in consideration of a width of a pattern, a density kernel in consideration of a density of a pattern, and an SRAF density kernel in consideration of pattern density of the SRAF.

5. The retarget process modeling method of claim 4, wherein the SRAF density kernel reflects the PR flow rate in such a manner that an effect of the SRAF pattern according to regions or pattern sizes of the SRAF pattern is subdivided and reflected thereto.

6. The retarget process modeling method of claim 4, wherein the SRAF density kernel reflects the PR flow rate by varying according to a direction of the SRAF pattern, a size of the SRAF pattern, and a distance between a main pattern and the SRAF pattern.

7. The retarget process modeling method of claim 6, wherein the variation is performed in such a manner that different weights are added to sections of the SRAF pattern divided according to a rule.

8. The retarget process modeling method of claim 4, wherein the SRAF density kernel is generated by dividing a radius R of a region in the visible kernel by a number n so as to divide the region into n radius sections each having a radius of R×(1 through n)/n, by dividing the region into m angle sections on either side of a center line, and by adding a same weight to each of n×m sections.

9. The retarget process modeling method of claim 7, wherein angles corresponding to positions of the SRAF pattern on either side, of the center line are references in dividing the region in the visible kernel into m angle sections.

10. A method of fabricating a mask, the method comprising:
generating a test mask according to a test layout with respect to a representative pattern;
obtaining measurement data using the test mask by performing an exposure operation on the representative pattern;
performing the retarget process modeling method of claim 1; and
generating a layout for the mask based on the second process model.

11. The method of claim 10, wherein the using the bias data step further comprises obtaining an After Flow Inspection (AFI) contour from an ADI model contour after an optical proximity correction (OPC) is performed by the first process model before correction.

12. The method of claim 10, wherein the PR flow kernel further comprises a visible kernel in consideration of a space between patterns, a blocked kernel in consideration of a width of a pattern, a density kernel in consideration of a density of a pattern, and an SRAF density kernel in consideration of pattern density of the SRAF.

13. The method of claim 12, wherein the SRAF density kernel reflects the PR flow rate in such a manner that an effect of the SRAF pattern according to regions or pattern sizes of the SRAF pattern is subdivided and reflected thereto.

14.-20. (canceled)

21. The retarget process modeling method of claim 1, wherein the obtaining prediction data step further comprises designing the test layout, and applying the first process model to the test layout.

22. The method of claim 10, wherein the obtaining prediction data step further comprises designing the test layout, and applying the first process model to the test layout.

23. The method of claim 10, wherein the obtaining the bias data step further comprises reflecting an After Development Inspection (ADI) critical dimension (CD) change of the representative pattern according to the PR flow rate.

24. The method of claim 12, wherein the SRAF density kernel reflects the PR flow rate by varying according to a direction of the SRAF pattern, a size of the SRAF pattern, and a distance between a main pattern and the SRAF pattern.

25. The method of claim 24, wherein the variation is performed in such a manner that different weights are added to sections of the SRAF pattern divided according to a rule.

26. The method of claim 12, wherein the SRAF density kernel is generated by dividing a radius R of a region in the visible kernel by a number n so as to divide the region into n radius sections each having a radius of R×(1 through n)/n, by dividing the region into m angle sections on either side of a center line, and by adding a same weight to each of n×m sections.

27. The method of claim 26, wherein angles corresponding to positions of the SRAF pattern on either side of the center line are references in dividing the region in the visible kernel into m angle sections.
